(19) United States
(12) Patent Application Publication
(10) Pub. No.: US 2008/0026217 A1
(43) Pub. Date: Jan. 31, 2008

(54) Method for preparing a photochromic nanoparticle and nanoparticle prepared therefrom

(76) Inventors: Hye Min Kim, Donghae-si (KR); Gi Ra Yi, Daejeon (KR); Sung Hyun Lim, Daejeon (KR); Young Jun Hong, Daejeon (KR); Kyung Woo Lee, Daejeon (KR); Yang Seung Jeong, Nam-gu (KR); Hyun Chul Ha, Bucheon-si (KR)

Correspondence Address: MCKENNA LONG & ALDRIDGE LLP, 1900 K STREET, NW, WASHINGTON, DC, 20006, US

(21) Appl. No.: 11/606,962

(22) Filed: Dec. 1, 2006

(30) Foreign Application Priority Data
Dec. 2, 2005 (KR) 2005-116840
Dec. 7, 2005 (KR) 2005-118753

(51) Int. Cl. B32B 19/00; B05D 7/00

(52) U.S. Cl. 428/357; 427/212

(57) ABSTRACT

The present invention provides a photochromic nanoparticle having a core-shell structure comprising (a) a polymer nano particle having a mean diameter controlled in a range of 10˜150 nm and containing a photochromic dye; and (b) a silicate inorganic polymer layer enveloping the polymer nanoparticle, and a method for preparing the same. The photochromic nanoparticle according to the present invention has structural and physical stability continuously in a long term and has transparency because of low light scattering, so that it can be applied to optical products.

This application claims the benefit of Korean Patent Application Nos. 10-2005-0116840 and 10-2005-0118753, filed Dec. 2, 2005 and Dec. 7, 2005, respectively in Korea, which are hereby incorporated by reference in their entirety for all purposes as if fully set forth herein.

### TECHNICAL FIELD

The present invention relates to a photochromic nanoparticle having transparency because of low light scattering and having a long-term stability resulted from the stable structure and a method for preparing the same.

### BACKGROUND ART

Photochromic dye is a material exhibiting UV-dependent color change, which is applicable to eye glasses, building windows, automobile windows, etc. Such a photochromic dye is applied on the support of a product as being dispersed in a dispersion medium or is mixed into the support itself to obtain the product. Generally, the stability of the photochromic dye is reduced by tree-radical generated by UV, resulting in the short life time.

To improve the stability of the photochromic dye, a material (for example, an antioxidant) that is able to react with free-radical earlier than the photochromic dye has been added to the dispersion medium or a UV absorbent has been added in order to absorb UV, one of the major factors involved in generation of free-radical, convert the UV into low energy and then emit it. However, the effect of the addition of such stabilizers as an antioxidant or an UV absorbent will be in question with the decrease of the stabilizer content as time goes by. Besides, the above stabilizers might be a reason of chemical changes of a photochromic dye and at the same time be an impurity.

To overcome the above conventional disadvantages, an alternative has been proposed, in which a photochromic dye is coated with an organic polymer to block free-radical. However, this method is only effective when the particle is size is big enough to be several micrometers, suggesting that optical nano-meter sized particles cannot be protected from oxygen or radical dependent stability decrease and photochromic loss with this coating method. It is thought that the the surface of nano-meter sized particles was not coated with the organic polymer uniformly.

An alternative has been proposed in U.S. Pat. No. 4,166,043, in which polymethylmethacrylate (PMMA) was dissolved in methylene chloride together with a photochromic dye and this solution was dispersed in ethanol to give plastic particles or cellulose acetate was dissolved in chloroform together with a photochromic dye. The solvent was removed, and then the solid precipitate was pulverized into particles by using a mill. And the product was coated with silicate to improve the stability of a photochromic dye. However, according to this method, dye selection is limited, that is a photochromic dye that is soluble only in a specific solvent can be selected and processes are complicated.

U.S. Pat. No. 5,017,225 describes a method for capsulation of a photochromic dye by coacervation using an organic component, gelatin. According to this method, the stability of a photochromic dye can be improved by adding an antioxidant and an UV absorbent into the microcapsule, but it is very difficult to prepare a microcapsule having the size of less than a few μm, making the application to a product asking high transparency difficult. As time goes by, the added antioxidant and UV absorbent are isolated from the photochromic dye by bleeding or blooming with reducing stability.

International Patent Publication No. WO02/055564 and U.S. Pat. No. 6,740,699 describe a method for capsulation of acryl or methacryl monomer together with a photochromic dye by mini emulsion polymerization. Particularly, olefin compound such as methylbutenol or cyclohexene is mixed and polymerized with a stabilizer to give a stable emulsion with a constant photochromic dye concentration for several months. However in these methods, polymerization monomers are limited to acryl monomer such as butylacrylate and low molecular weight olefin stabilizer is added, so that the concentration of the stabilizer is decreased and the sub-reaction speed is accelerated with reducing stability of the dye.

### BRIEF DESCRIPTION OF THE DRAWINGS

The application of the preferred embodiments of the present invention is best understood with reference to the accompanying drawings, wherein:

FIG. 1 is a sectional view illustrating the structure of the photochromic nanoparticle according to the present invention.

FIG. 2 is a photograph of transmittance electron microscope (TEM) illustrating the photochromic nanoparticle prepared in Example 1.

### DISCLOSURE OF THE INVENTION

It is an object of the present invention to provide a photochromic nanoparticle having a structural and physical stability improved by using silicate, which provides physical block from the the outside as well as easy formation of a coating layer, as a shell enveloping a core containing a photochromic dye.

It is another object of the present invention to provide a method for preparing the above photochromic nanoparticle, and a photochromic article containing the photochromic nanoparticle.

To achieve the above objects, the present invention provides a photochromic nanoparticle having the core-shell structure which comprises: (a) a polymer nanoparticle having a mean diameter controlled in a range of 10˜150 nm and containing a photochromic dye; and (b) a silicate inorganic polymer layer enveloping the polymer nanoparticle, and a photochromic article containing the photochromic nanoparticle.

The present invention also provides a method for preparing the photochromic nanoparticles, which comprises: (a) preparing a polymer nanoparticle containing a photochromic dye while controlling a mean diameter of the polymer nanoparticle in a range of 10˜150 nm; and (b) forming a silicate inorganic polymer layer on the surface of the polymer nanoparticle.

Hereinafter, the present invention is described in detail.

In order to secure the structural and physical stability of the photochromic nanoparticle (10), the present invention uses silicate as a shell component (12) for protecting the core (11) containing a photochromic dye from the outside.

The silicate is an inorganic polymer having a 3-dimensional network framework. The silicate inorganic polymer can be formed continuously and uniformly by polymerization and is able to protect a photochromic dye physically from some materials that can be sub-reacted with the photochromic dye, owing to a dense network framework of the silicate, thereby maintaining the stability of the final photochromic nanoparticle. In case that the silicate inorganic polymer layer is formed, it is not necessary to include a dye stabilizer such as antioxidant or UV absorbent in the photochromic nanoparticle, so that sub-reaction of the stabilizer does not occur according to the passage of time.

However, even though the silicate inorganic polymer layer is formed on the surface of the core, the stability is not always equally secured. Therefore, to maximize the effect of the silicate inorganic polymer layer formed on the core particle containing the photochromic dye, which is to improve the stability of the photochromic nanoparticle, the present invention is characterized by regulating factors such as mean diameter (size) of the core particle containing the photochromic dye and/or surface property of the core particle.

The stability effect by the silicate inorganic polymer layer varies depending on the mean diameter (size) of the core particle containing the photochromic dye. It is presumed because the uniformity of the silicate layer varies depending on the degree of dispersion of the core particle in an aqueous dispersion. In order to have a stable dispersion of the core particle in an aqueous dispersion, it is preferable that the dispersed core particle is as minute and uniform as possible. So, the invention is characterized by regulating the mean diameter of the core particle containing the photochromic dye as up to 150 nm. It is confirmed through exemplary embodiments of the invention that the stability increases significantly with the reduction of the mean diameter (size) of the final photochromic nanoparticle (Table 1). In addition, the smaller the mean diameter of the particle, the greater the transparency of the product becomes, suggesting that the minimized particle is in good shape for optical use.

It is preferable that a polymer of the core particle has a functional group having an affinity for the aqueous dispersion, thereby to improve dispersion of the core particle and to allow a formation of uniform silicate inorganic polymer layer, resulting in enhancement of the stability of the photochromic nanoparticle. For example, the polymer of the core particle has a hydrophilic substituent on its surface.

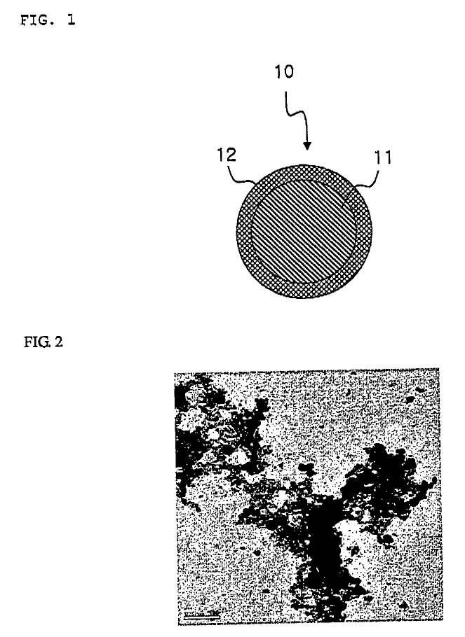

The photochromic nanoparticle of the present invention has the core-shell structure to improve stability of the photochromic dye, more precisely the core-shell structure in which the core particle containing a photochromic dye (a) is coated with a coating layer (b) (see FIG. 1).

Preferably, the coating layer (b) in the photochromic nanoparticle is made of silicate which has excellent coating capacity and a high denseness, to minimize the reaction between the photochromic dye contained in the core particle and other factors such as free-radical and oxygen. Particularly, silicate is an inorganic polymer having a 3-dimensional network framework formed continuously by polymerization, therefore to constantly endow physical or structural stability to the photochromic nanoparticle.

The silicate inorganic polymer layer can be formed by the polymerization of conventional alkoxy silane compound, which is well-known to those in the art. At this time, the alkoxy silane compound can be represented by the following formula 1.
SiR¹ₚR²₄₋ₚ [Formula 1]

wherein,

R¹ is H, aryl, vinyl, allyl, or C₁-C₄ straight or branched alkyl substituted or not substituted with F,

R² is C₁-C₄ straight or branched alkoxy, and

p is an integer of 0-2.

Before the silicate inorganic polymer layer is formed on the surface of the core particle by using a first alkoxy silane compound forming the silicate inorganic polymer layer, it is preferable to adsorb a second alkoxysilane compound having both a polymerizable group and a silane group onto the core nanoparticle. When the second alkoxysilane compound adsorbs onto the core nanoparticle, it is possible to polymerize the polymerizable group of the second alkoxysilane with the polymer of the core nanoparticle and to co-polymerize the silane group of the second alkoxysilane compound with the first alkoxysilane compound, thereby allowing the core particle to bind with the shell layer tightly. At this time, the polymerizable group is not limited to a specific one and exemplified by epoxy group and acryl group, etc.

The thickness of the silicate inorganic polymer layer is also regulated, considering the dispersion degree in an aqueous dispersion and the blocking effect for the photochromic dye, which is preferably 5˜15 nm to maintain transparency and to allow the blocking effect.

The core particle (a) in the photochromic nanoparticle according to the present invention contains a conventional photochromic dye and there is no limitation as long as the mean diameter of the core particle is 150 nm or less. A polymer particle containing a photochromic dye is preferred as the core particle, considering easy production process and regulation of particle size.

According to the present invention, the photochromic dye is present in the core particle in such a manner that i) the photochromic dye is adsorbed physically or chemically on the surface of the polymer of the core particle; and/ox (ii) the photochromic dye is absorbed (permeated) into the inside of the polymer of the core particle and forms a chemical bond.

The photochromic dye is not limited to a specific kind and any general photochromic dye well-known to those in the art is acceptable which is exemplified by spiroxazine, spiropyran, naphthopyran, fulgimide, azobenzine, or a mixture of one or more of these compounds.

It is preferable that the core polymer containing the photochromic dye has a functional group having an affinity for a dispersion medium on its surface for stable dispersion. Water dispersion medium is generally used, so at least one hydrophilic functional group is preferably included. It is preferred, to accelerate the coloring speed of a photochromic dye, that glass transition temperature (T_{g}) of the core polymer is as low as possible, which is for example 30˜50° C. The weight average molecular weight of the core polymer might be 10,000˜300,000, which is not limited thereto. The core polymer preferably cross-linked, allowing the core polymer to entangle with the photochromic dye, or to be insoluble. The core polymer can be selected from a group consisting of polyurethane, polyacryl, polyepoxy, polyester, polystyrene (PS), polyacrylate (PA), polydimethylsiloxane (PDMS) and a mixture of at least one of these compounds, which is not limited thereto.

It is also preferred for the core polymer particle to be as small as possible in order to reduce scattering and improve dispersion degree, which is preferably 10˜200 nm and more preferably 30˜100 nm.

The content of the photochromic dye in the core particle is 0.8˜30 weight part based on 100 weight part of the core polymer particle, which is not limited thereto.

The core particle of the invention comprising the photochromic dye and the core polymer can additionally include a generally acceptable additive such as a surfactant, etc, and at this time, two or more different surfactants might be added.

The photochromic nanoparticle of the invention can be prepared by applicating a conventional method well-known to those in the art, for example a method comprising the steps of (a) preparing a polymer nanoparticle containing a photochromic dye while controlling a mean diameter of the polymer nanoparticle in a range of 10˜150 nm; and (b) forming a silicate inorganic polymer layer on the surface of the polymer nanoparticle.

1) step of preparing a polymer nanoparticle containing a photochromic dye while controlling a mean diameter of the polymer nanoparticle in a range of 10˜150 nm

First, a polymer nanoparticle containing the photochromic dye with mean diameter of 10˜150 nm is prepared by either of the following examples.

\textcircled{1} A first example uses polymerization forming nano emulsion. Herein, the emulsion having the size of the emulsified particle in a range of 100˜200 nm is indicated as ‘nano-emulsion’.

According to a preferable embodiment of the first example, a polymer nanoparticle containing a photochromic dye is prepared by the following steps:

(i) preparing a nano-emulsion by mixing a first solution containing the photochromic dye, a polymer, a first surfactant and an organic solvent and a second solution containing a second surfactant having higher hydrophilicity than that of the first surfactant and water, thereby to form nano-emulsion; and

(ii) eliminating the organic solvent from the nano-emulsion.

At this time, the content of each component of the first solution can be properly regulated. It is preferable that the first solution comprises 2˜5 weight part of the polymer, 0.8˜2 weight part of the photochromic dye, 2˜5 weight part of the first surfactant and the balance amount of the organic solvent based on 100 weight part of the total weight of the first solution.

When the content of the photochromic dye in the first solution is 0.8˜2 weight part, coloring effect under UV-irradiation is satisfactory, and the photochromic dye remains therein without being extracted. When the content of the first surfactant is 2˜5 weight part, the emulsion is stable and the silicate inorganic polymer layer successfully coats the surface of the nanoparticle. The content of the organic solvent is determined as to make the total volume as 100 weight part as long as the organic solvent dissolves the polymer absolutely. The content of the polymer is 2˜5 weight part as described above.

The first surfactant in the first solution plays a role in stabilizing the particles. The first surfactant can be nonionic, cationic or anionic. The unlimited example of the nonionic surfactant is octyl phenol ethoxylate or polysorbate. The unlimited example of the cationic surfactant is cetyltrimethylammonium bromide (CTAB). The unlimited example of the anionic surfactant is sodium dodecyl sulfate, sodium dodecyl benzene sulfonate or sodium sulfonate.

The organic solvent used in the first solution is to dissolve the photochromic dye. As long as the organic solvent is not miscible with water which is a solvent of the second solution, there is no limitation in the organic solvent. The unlimited example of the organic solvent is hydrocarbon solvents, ketone solvents, ester solvents, or a mixture of one or more of these compounds.

The second solution, which will be mixed with the first solution, is an aqueous solution in which the second surfactant is dispersed or dissolved. At this time, the second surfactant is not limited to a specific one as long as it has higher hydrophilicity than that of the first surfactant.

The second surfactant can be a nonionic surfactant such as octyl phenol ethoxylate, polysorbate or a mixture of at least one of them, which is not limited thereto. It is preferable that the second solution comprises 1˜5 weight part of the second surfactant based on 100 weight part of the total weight of the second solution If the content of the second surfactant is less than 1 weight part, the stabilization effect on the polymer particle will be in question. On the other hand, if the content is more than 5 weight part, silicate coating layer on the surface of the core particle will not be formed uniformly.

It is preferable that the mixing ratio of the first solution:the second solution is 1:5˜30, more preferably 1:10˜20. If the mixing ratio is out of the range, the emulsion will not be stable and thus optical density of the final nanoparticle will not meet the wanted level.

The emulsion prepared by mixing the first solution and the second solution is an O/W (oil in water) emulsion wherein the polymer solution forms liquid drops in water as a medium. This emulsion is changed into particles after eliminating the organic solvent. Thus, it is preferred to minimize the size of the emulsion. To minimize the size of the emulsion, a homogenizer and/or a microfluidizer can be used so that the size of the emulsion can be regulated in the range of 100˜200 nm. If the size of the nano-emulsion is less than 100 nm, coagulation will be occurred during the elimination of the organic solvent. On the other hand, if the size is more than 200 nm, microparticles are not obtained, so that transparency will be decreased.

As explained hereinbefore, the organic solvent is eliminated from the nano-emulsion. The method of eliminating the organic solvent can be any conventional method known to those in the art. For example, the nano-emulsion can be just left in order for the organic solvent to evaporate itself or the organic solvent can be selectively eliminated by fractional distillation. There is no limitation in the temperature for eliminating the organic solvent, but 20˜100° C. is preferred. If the temperature is lower than 20° C., evaporation of the solvent will not be successful, whereas the temperature is higher than 100° C., coagulation among the polymer nanoparticles cannot be avoid.

After eliminating the organic solvent, polymer nanoparticles containing a photochromic dye are obtained as being dispersed in an aqueous solution.

\textcircled{2} The second example for preparing a polymer nanoparticle containing a photochromic dye is that the polymer nanoparticle having pre-regulated mean diameter of 10˜150 nm is permeated with a photochromic dye. In this method, a process to regulate the mean diameter of the polymer nanoparticle is not necessary, thereby making the production process simple.

According to a preferable embodiment of the second example, the permeation of photochromic dye into the polymer nanoparticle is performed by mixing a first solution containing the photochromic dye and an organic solvent and a second solution having the polymer nanoparticle dispersed in water.

It is preferable that the content of the photochromic dye in the first solution is 1˜30 weight part, more preferably to 5˜25 weight part, based on 100 weight part of the total weight of the first solution. If the content of the photochromic dye is less than 1 weight part, optical density does not reach the wanted level. If the content is more than 30 weight part, which means the photochromic dye is excessively added more than required, the dye remains without permeation into the polymer nanoparticle.

It is preferable that the content of the polymer nanoparticle in the second solution is 10˜30 weight part, more preferably 15˜25 weight part, based on 100 weight part of the total weight of the second solution. If the content of the polymer nanoparticle is out of the above acceptable range, optical density and stability of the particle will not reach the wanted level.

The mixing ratio of the first solution to the second solution can be regulated within an acceptable range, considering optical density and the maximum content of photochromic dye for complete permeation into the organic polymer nanoparticle. And the content of the photochromic dye in 100 weight part of the polymer nanoparticle is preferably 1˜30 weight part and more preferably 5˜25 weight part.

The temperature for mixing the first solution and the second solution is not necessarily fixed but 10˜80° C. is preferred. If the temperature is lower than 10° C., permeation of the photochromic dye is not successful, whereas if the temperature is higher than 80° C., stabilization of the particles will be in question. And continuous stirring is recommended during the mixing.

After complete permeation of the photochromic dye into the organic polymer nanoparticle, the organic solvent is selectively eliminated, and as a result, the nanoparticles containing the photochromic dye are obtained as being dispersed in an aqueous solution. The method of eliminating the organic solvent is the same as described above.

2) step of forming a silicate inorganic polymer layer on the surface of the polymer nanoparticle containing the photochromic dye.

The method for forming the silicate inorganic polymer layer on the surface of the polymer nanoparticle can be performed by the conventional methods known to those in the art. For example, when alkoxysilane compounds are added in the presence of an acid catalyst or a base catalyst, sol-gel reaction is occurred thereby to form a silicate inorganic polymer layer on the surface of the polymer nanoparticle. The sol-gel reaction in the present invention indicates the process that colloid in sol state is first prepared and then gelation of the sol allows to change the liquid phase into a network structure (gel), resulting in the inorganic network. The precursor for forming the colloid can be the above-described alkoxysilane or metal alkoxide in which metal or metalloid elements are enveloped by various reactive ligands, and this metal alkoxide is also included in the criteria of the present invention.

The acid catalyst or base catalyst can be selected among general catalysts accepted by those in the art and ammonia water is an example.

The aqueous dispersion used for forming the silicate layer through sol-gel reaction can additionally include at least one of alcohol selected from a group consisting of ethanol, methanol, isopropyl alcohol and butanol. And the pH of the aqueous dispersion for sol-gel reaction is preferably 7˜11. If the pH is lower than 7, stable photochromic nanoparticles will not be obtained. If the pH is higher than 11, the coating with the silicate shell will not be uniform.

The method of the invention preferably includes an additional step during the formation of the silicate inorganic polymer layer, which is adding and adsorbing a different kind of alkoxysilane compound onto the surface of the core polymer nanoparticle, before adding the above-described alkoxysilane compound forming the silicate inorganic polymer layer and the catalyst. The alkoxysilane compound preferably contains both a polymerizable group and a silane group. At this time, it is preferred for polymerizable group to have an affinity for the core polymer nanoparticle for satisfactory adsorption. The acceptable alkoxysilane compound can be selected from a group consisting of methacryloxypropyltrimethoxysilane, acryloxysilane and a mixture thereof, but not limited thereto.

The photochromic nanoparticle prepared by the method of the invention has up to 100 nm in mean diameter, suggesting that it has transparency of up to 1.2% haze and optical stability enduring for at least 23 hours (see Table 1). For reference, the optical stability is determined by the time (QUV) that reduces the difference of the initial optical density (ΔOD) down to half.

The present invention also provides a photochromic article containing the photochromic nanoparticle.

The photochromic article herein is exemplified by a photochromic device such as photochromic recorder, image parts, video parts, lenses, etc, and further includes pigment, dye and ink, etc containing the photochromic nanoparticle. For example, the photochromic article can be photochromic eye glasses, photochromic film and photochromic ink, etc, but not limited thereto.

### MODE FOR CARRYING OUT THE INVENTION

Practical and presently preferred embodiments of the present invention are illustrative as shown in the following Examples.

However, it will be appreciated that those skilled in the art, on consideration of this disclosure, may make modifications and improvements within the spirit and scope of the present invention.

### EXAMPLES 1˜6

### EXAMPLE 1

To 10 g of toluene were added 0.2 g of polystyrene having weight average molecular weight of 150,000, 0.08 g of a photochromic dye (Palatinate Purple, James Robinson) and 0.2 g of a surfactant (Triton x-100) to prepare a polymer solution. A surfactant (Tween 40) was dissolved in water at the concentration of 3 wt % to prepare 100 g of surfactant solution. The polymer solution and the surfactant solution were mixed and treated with a homogenizer for 2 minutes to prepare a micrometer sized emulsion. The emulsion was treated with a microfluidizer three times to give a nano-emulsion. The size of the nano-emulsion was measured with a particle size analyzer (UPA 150, Microtrac), and as a result, 170 nm sized nano-emulsion was prepared.

The nano-emulsion aqueous solution was filled in a plastic bottle and stood at zoom temperature (25° C.) for 2 days with the lid off to evaporate toluene. The content of toluene in the nano-emulsion was measured by gas chromatography. The initial content of toluene was 7 weight % and reduced to 0.42 weight % after evaporation.

The size of the photochromic polymer nanoparticle obtained after toluene evaporation was measured by UPA and TEM, and the TEM photograph is shown in FIG. 2. In FIG. 2, the length of a scale bar is 500 nm. The mean diameter of the polymer nanoparticle before forming the silicate shell was approximately 50 nm.

To 70 mL of aqueous dispersion containing the polymer nanoparticles were added 30 mL of water and 28 weight % of NH₄OH aqueous solution and pH of the solution was adjusted to 10. 1 mL of tetraethylorthosilicate (TEOS) and 1 mL of ethanol were added drop by drop, leading to sol-gel reaction to give the photochromic nanoparticle with the silicate shell. TEM result confirmed that the thickness of the silicate shell in the resulting photochromic nanoparticle was 10 nm.

### EXAMPLE 2

A photochromic nanoparticle was prepared by the same manner as described in Example 1 except that polydimethylsiloxane (weight average molecular weight; 37,000) was used instead of polystyrene. The mean diameter of the photochromic nanoparticle before forming the silicate shell was 40 nm and the thickness of the silicate shell was confirmed to be up to 10 nm.

### EXAMPLE 3

A photochromic nanoparticle was prepared by the same manner as described in Example 1 except that a polymer solution was prepared by adding 10 g of polystyrene (weight average molecular weight: 150,000), 2 g of a photochromic dye (Palatinate Purple, James Robinson) and 0.8 g of a surfactant (Triton x-100) to 30 g of toluene.

The mean diameter of the photochromic nanoparticle before forming the silicate shell was 80 nm and the thickness of the silicate shell was up to 9 nm.

### EXAMPLE 4

0.8 g of a photochromic dye (Palatinate Purple, James-Robinson) was dissolved in 10 g of tetrahydrofurane (THF) to prepare 10.8 g of photochromic dye solution. 100 g of polyurethane aqueous dispersion (DAIICHI KOGYO SEIYOKU, SUPERFLEX 107 M) containing 15 wt % of the polyurethane nanoparticles having the size of upto 30 nm was prepared. The photochromic dye solution and the polyurethane aqueous dispersion were mixed by stirring for 3 hours at room temperature (25° C.), which stood for 48 hours at room temperature to eliminate the organic solvent.

After completely eliminating the organic solvent from the aqueous dispersion containing the polyurethane nanoparticles with the photochromic dye permeated, 0.5 g of NH₄OH aqueous solution (28 wt %) was added to adjust pH to 10. To the aqueous dispersion was added 1 g of methacryloxypropyltrimethoxysilane (MPS) to adsorb MPS onto the surface of the polyurethane nanoparticle. Further, 1 g of tetraethylorthosilicate (TEOS) was added, followed by sol-gel reaction at 25° C. to give the photochromic nanoparticle coated with the silicate layer. The thickness of the silicate shell was up to 10 nm.

### EXAMPLE 5

A photochromic nanoparticle was prepared by the same manner as described in Example 4 except that 90 g of polyurethane aqueous dispersion (SUPERFLEX 600) was used instead of 100 g of the polyurethane aqueous dispersion (SUPERFLEX 107M) containing 15 wt % of polyurethane nanoparticles of up to 30 nm in mean diameter and 10 g of ethanol was added before adding ammonia water after eliminating the organic solvent. The thickness of the formed silicate shell was up to 10 nm.

### EXAMPLE 6

A photochromic nanoparticle was prepared by the same manner as described in Example 4 except that the content of the polyurethane aqueous dispersion (SUPERFLEX 107M) containing 15 wt % of the polyurethane nanoparticles of up to 30 nm in mean diameter was reduced from 100 g to 90 g, 10 g of ethanol was added before adding ammonia water after eliminating the organic solvent, and pH was adjusted to 11 by adding 28 wt % of ammonia water before adding TEOS after MPS absorption. The thickness of the formed silicate shell was up to 10 nm.

### COMPARATIVE EXAMPLE 1

To 100 g of styrene were added 0.05 g of an initiator (V65), 4.0 g of hexadecan, 0.1 g of LA-82, 5 g of methacroxypropyltrimethoxysilane and 5 g of a photochromic dye (Palatinate purple) to prepare a polymer solution. 10 g of sodiumlaurylsulfate was dissolved in 300 g of deionized water to prepare a surfactant solution.

The prepared polymer solution and the surfactant solution were mixed and treated with an ultrasonicator for 5 minutes, resulting in mini-emulsion. The mini-emulsion was polymerized by heating for 5 hours at 60˜90° C. with slowly stirring in a batch-type reactor. The resultant photochromic latex was centrifuged for 2 hours with 17,000 rpm by a centrifuge (MEGA17R, Hanil) and the precipitate was redispersed in water. The centrifugation-redispersion process was repeated three times to give LATEX with elimination of an emulsifying agent. To 10 g of the emulsifying agent excluded LATEX (solid content: 17%) were added 200 g of water, 20 g of EtOH and 2.5 g of ammonia water (17 wt %), followed by stirring. 5 g of tetraethoxysilane was added for 12 hours during the stirring. As a result, the photochromic nanoparticle coated with the silicate shell by sol-gel reaction was prepared.

### EXPERIMENTAL EXAMPLE 1

### Physical Properties of the Photochromic Nanoparticle

1-1. Transparency

Water dispersions containing photochromic nanoparticles of Examples 1˜6 and Comparative Example 1 were mixed with water-soluble polyurethane resin Superflex 107M (DAI-ICHI KOGYO SEIYAKU Co. Ltd, solid content: 25%) at the ratio of 1:1, followed by spin coating on the glass plate at 500 rpm for 20 sec. Then transparency was measured by a haze meter.

1-2. Photochromic Property

The glass plate coated with the photochromic nanoparticles prepared in Examples 1˜6 and Comparative Example 1 was irradiated with 365 nm UV (1.35 mW/cm²) for three minutes and then output power in coloring state was measured by using UV-Vis analyzer.

The photochromic property of the photochromic nanoparticle was determined by the difference of optical density (ΔOD) calculated by the following mathematical formula 1.

$$Δ OD = log ( \frac{T \% bleached}{T \% activated} ) \qquad [ Mathematical Formula 1 ]$$

In the above formula, ‘T % bleached’ indicates the optical transmittance as it was transparent and ‘T % activated’ indicates the optical transmittance as it was activated after three minute-irradiation with 365 nm of UV (1.35 mW/cm²).

1-3. Stability

The stability of the photochromic nanoparticle was investigated by Quick UV test and determined by the degree of the decrease of optical density. Particularly, it is determined by the time that reduces the difference of the initial optical density (ΔOD) down to half. When it took 0˜25 hours to cut down the difference level to half, it was judged as ‘normal’. When it took 25˜50 hours, it was judged as ‘good’ and when it took at least 50 hours, it was judged as ‘excellent’. The results of the above measurements are shown in Table 1.

TABLE 1

| | | | | Difference | |
|---|---|---|---|---|---|
| | | | | of optical | |
| | Mean | | Trans- | density | |
| | diameter (nm) | | parency | (ΔOD) | Stability |
| | Core | Shell | (%) | (λₘₐₓ = 580 nm) | (QUV, Hr) |
| Example 1 | 50 | 10 | 0.7 | 0.53 | Good |
| | | | | | (40 hrs) |
| Example 2 | 40 | 10 | 0.8 | 0.62 | Excellent |
| | | | | | (55 hrs) |
| Example 3 | 80 | 9 | 1.2 | 0.75 | Normal |
| | | | | | (23 hrs) |
| Example 4 | 30 | 10 | 0.70 | 0.55 | Excellent |
| | | | | | (50 hrs) |
| Example 5 | 30 | 10 | 0.75 | 0.70 | Excellent |
| | | | | | (55 hrs) |
| Example 6 | 30 | 10 | 0.78 | 0.60 | Good |
| | | | | | (35 hrs) |
| Comparative | 260 | 10 | 2.1 | 0.41 | Normal |
| Example 1 | | | | | (15 hrs) |

As a result, the photochromic nanoparticle prepared by the present invention exhibited constant stability, while the photochromic nanoparticle prepared in Comparative Example showed reduced stability even though it was coated with the silicate shell layer (see Table 1). This result indicates that the silicate inorganic polymer layer coating itself does not guarantee the stability of the final photochromic nanoparticle. As shown in table 1, it was possible to confirm that the important factors affecting the stability of the particle were the size of the core particle and the characteristics of its surface. That is, the physical and structural stability of the photochromic nanoparticle could be improved by regulating the size and the characteristics of the surface of the core particle. Further, it was possible to confirm that the photochromic nanoparticle can be effectively used for optical products and for the prevention of a counterfeit note.

### INDUSTRIAL APPLICABILITY

As explained hereinbefore, the photochromic nanoparticle of the present invention has advantages of structural stability and easy size regulation, so that it contributes to the constant stability of a photochromic dye.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A photochromic nanoparticle having a core-shell structure which comprises:
(a) a polymer nanoparticle having a mean diameter controlled in a range of 10˜150 nm and containing a photochromic dye; and
(b) a silicate inorganic polymer layer enveloping the polymer nanoparticle.

2. The photochromic nanoparticle according to claim 1, wherein the silicate inorganic polymer layer has a 3-dimensional network framework formed continuously by the polymerization of a first alkoxysilane compound.

3. The photochromic nanoparticle according to claim 2, wherein the first alkoxysilane compound is represented by the following formula 1.
SiR¹ₚR²₄₋ₚ [Formula 1]
wherein,
R¹ is H, aryl, vinyl, allyl, or C₁-C₄ straight or branched alkyl substituted or not substituted with F; R² is C₁-C₄ straight or branched alkoxy; and p is an integer of 0-2.

4. The photochromic nanoparticle according to claim 2, wherein the silicate inorganic polymer layer is formed by adsorbing a second alkoxysilane compound having both a polymerizable group and a silane group onto the polymer nanoparticle, polymerizing the polymerizable group of the second alkoxysilane with the polymer nanoparticle; and co-polymerizing the silane group of the second alkoxysilane compound with the first alkoxysilane compound forming the silicate inorganic polymer layer.

5. The photochromic nanoparticle according to claim 1, wherein the thickness of the silicate inorganic polymer layer is 5˜15 nm.

6. The photochromic nanoparticle according to claim 1, wherein the photochromic dye is present in the polymer nanoparticle in such a manner that
i) the photochromic dye is adsorbed physically or chemically on the surface of the polymer nanoparticle; and/or
(ii) the photochromic dye is absorbed into the inside of the polymer nanoparticle and forms a chemical bond.

7. The photochromic nanoparticle according to claim 1, wherein the polymer nanoparticle has at least one hydrophilic functional group on its surface and is soluble in a water dispersion medium.

8. The photochromic nanoparticle according to claim 1, wherein the photochromic dye is selected from a group consisting of spiroxazine, spiropyran, naphthopyran, fulgimide and azobenzine, and the polymer of the polymer nanoparticle is selected from a group consisting of polyurethane, polyacryl, polyepoxy, polyester, polystyrene (PS), polyacrylate (PA) and polydimethylsiloxane (PDMS).

9. The photochromic nanoparticle according to claim 1, wherein the polymer nanoparticle has a weight average molecular weight of 10,000˜300,000 and a glass transition temperature (T_{g}) of 30˜50° C.

10. A photochromic article containing the photochromic nanoparticles as defined in claim 1.

11. A method for preparing the photochromic nanoparticles as defined in claim 1, which comprises:
(a) preparing a polymer nanoparticle containing a photochromic dye while controlling a mean diameter of the polymer nanoparticle in a range of 10˜150 nm; and
(b) forming a silicate inorganic polymer layer on the surface of the polymer nanoparticle.

12. The method according to claim 11, wherein the step (b) of forming the silicate inorganic polymer layer is performed by sol-gel reaction in the presence of a catalyst and a first alkoxysilane compound represented by formula 1 in the aqueous dispersion in which the polymer nanoparticle containing the photochromic dye is dispersed.
SiR¹ₚR²₄₋ₚ [Formula 1]
wherein,
R¹ is H, aryl, vinyl, allyl, or C₁-C₄ straight or branched alkyl substituted or not substituted with F; R² is C₁-C₄ straight or branched alkoxy; and p is an integer of 0-2.

13. The method according to claim 11, wherein the step (b) of forming the silicate inorganic polymer layer further comprises adsorbing a second alkoxysilane compound having a polymerizable group and a silane group onto the surface of the polymer nanoparticle in the aqueous dispersion in which the polymer nanoparticle containing the photochromic dye is dispersed, before adding the first alkoxysilane compound forming the silicate inorganic polymer layer.

14. The method according to claim 11, wherein the step (a) of preparing a polymer nanoparticle containing a photochromic dye comprises:
(i) preparing a nano-emulsion by mixing a first solution containing the photochromic dye, a polymer, a first surfactant and an organic solvent and a second solution containing a second surfactant having higher hydrophilicity than that of the first surfactant and water; and
(ii) eliminating the organic solvent from the nano-emulsion.

15. The method according to claim 14, wherein the first solution comprises 2˜5 weight part of the polymer, 0.8˜2 weight part of the photochromic dye, 2˜5 weight part of the first surfactant and the balance amount of the organic solvent based on 100 weight part of the total weight of the first solution, and the second solution comprises 1˜5 weight part of the second surfactant based on 100 weight part of the total weight of the second solution.

16. The method according to claim 14, wherein the mixing ratio of the first solution:the second solution is 1:5˜30.

17. The method according to claim 14, wherein the mixing of the first solution and the second solution in the step (i) is performed by using homogenizer or microfluidizer.

18. The method according to claim 11, wherein the step (a) of preparing a polymer nanoparticle containing a photochromic dye comprises: mixing a first solution containing the photochromic dye and an organic solvent and a second solution having the polymer nanoparticle dispersed in water, and permeating the photochromic dye into the polymer nanoparticle.

19. The method according to claim 18, wherein the content of the photochromic dye in the first solution is 1˜30 weight part based on 100 weight part of the total weight of the first solution, and the content of the polymer nanoparticle in the second solution is 10˜30 weight part based on 100 weight part of the total weight of the second solution.

20. The method according to claim 18, wherein the first solution and the second solution are mixed at the weight ratio that allows the ratio of the polymer nanoparticle:the photochromic dye to be 100:1˜30 weight part.
